(19) United States
(12) Patent Application Publication
(10) Pub. No.: US 2026/0164293 A1
(43) Pub. Date: Jun. 11, 2026

(54) NETWORK TRAFFIC MANAGEMENT FOR GENERATIVE CONTENT

(71) Applicant: AT&T Intellectual Property I, L.P., Atlanta, GA (US)

(72) Inventors: Yupeng Jia, South Pasadena, CA (US); Hongyan Lei, Plano, TX (US)

(21) Appl. No.: 18/976,317

(22) Filed: Dec. 10, 2024

(51) Int. Cl. H04W 28/02

(52) U.S. Cl. CPC H04W 28/0263

(57) ABSTRACT

A processing system including at least one processor in a communication network may receive a request from a client device to a generative artificial intelligence system requesting a creation of a generative content. The processing system may next obtain a data stream comprising the generative content from the generative artificial intelligence system and determine that the data stream comprises the generative content. The processing system may then apply a differentiated processing to the data stream in the communication network in accordance with an indicator in one or more packets of the data stream indicating that the data stream comprises the generative content.

The present disclosure relates generally to network operations, and more particularly to methods, non-transitory computer-readable media, and apparatuses for applying a differentiated processing to a data stream in a communication network in accordance with an indicator in one or more packets of the data stream indicating that the data stream comprises the generative content.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance. In one instance, a cellular network implementing 5G may be used to transport content that may contain generative content.

### SUMMARY

In one example, the present disclosure discloses a method, computer-readable medium, and apparatus for applying a differentiated processing to a data stream in a communication network in accordance with an indicator in one or more packets of the data stream that the data stream comprises the generative content. For example, a processing system including at least one processor deployed in a communication network may receive a request from a client device to a generative artificial intelligence system requesting a creation of a generative content. The processing system may next obtain a data stream comprising the generative content from the generative artificial intelligence system and determine that the data stream comprises the generative content. The processing system may then apply a differentiated processing to the data stream in the communication network in accordance with an indicator in one or more packets of the data stream indicating that the data stream comprises the generative content.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for applying a differentiated processing to a data stream in a communication network in accordance with an indicator in one or more packets of the data stream indicating that the data stream comprises the generative content; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for applying a differentiated processing to a data stream in a communication network in accordance with an indicator in one or more packets of the data stream indicating that the data stream comprises the generative content. In particular, examples of the present disclosure intelligently detect data traffic for generative content (e.g., generative artificial intelligence (AI) and/or machine learning (ML)-based generative content) across a communication network. In one example, the present disclosure may implement a predefined signaling indicator (e.g., one or more data bits) to indicate that certain data traffic comprises AI/ML generative content (which may be referred to herein as AI generative content, or simply “generative content”) or is associated with generative content (e.g., signaling messages for requesting and delivering the generative content, retrieval augmented generation (RAG)/supplemental prompt content transmission, etc.). In one example, client devices and/or generative content servers may notify the communication network when transmitting generative content data traffic using such a signaling indicator. Alternatively, or in addition, a communication network may detect generative content data traffic on its own, e.g., at a network edge, and may append the data traffic with such a signaling indicator for differentiated processing within the communication network. In one example, the present disclosure may implement a ML-based system (e.g., using a language model or “large language model” (LLM)) with advanced features such as retrieval-augmented generation (RAG) to improve detection and/or response accuracy. For instance, service or event triggers may cause the communication network to modify and augment such a LLM via RAG, which may result in a change in the behavior in classification and/or a change in the differentiated processing that may be applied to generative content data traffic for one or more client devices across the communication network. In one example, the present disclosure may balance on-device processing (e.g., using a compact language model) with public, private, and/or edge cloud processing to reduce network load or to otherwise improve network performance. Thus, the communication network may adaptively manage network traffic associated with generative content for both static and mobile scenarios.

Notably, AI/ML, particularly relating to LLMs or other types of generative MLMs, has become a cornerstone feature in flagship devices, driven by the immense potential of generative AI/ML. For example, various use cases for generative models include camera enhancements, text generation and auto-completion, voice assistant and translation services, video content generation, gaming, and so forth. As more generative models are integrated into devices, architectures are increasingly being implemented having a mix of on-device computing for simpler tasks and cloud reliance for more complex interactions. Generative AI/ML model service deployments may also include real-time services and non-real-time services. The impact of network data traffic varies by use cases, with emerging generative AI/ML capabilities, such as text-to-video, expected to significantly increase network data traffic. Examples of the present disclosure thus enable a communication network to identify that data traffic is for AI/ML generative content and to further select and apply a differentiated processing to such data traffic, such as a different routing than that which is applied to other kinds of data traffic, a different network slice assignment, a different priority of handling and/or a different bandwidth allocation, a different service level commitment, and so forth.

In an illustrative example, a user may activate an application via an endpoint device, e.g., a client device. For instance, the application may comprise a dedicated generative content application, or may comprise an application that is associated with generative content, such as a mail application, a text messaging application, a social media/social networking application, and so forth. In one example, a generative content application may comprise a plug-in or add-on to another application, such as a digital assistant tool that integrates with a mail application, a text message application, etc. In one example, the client device, e.g., via the application, may mark data traffic from the client device to a generative AI system as being generative content data traffic. For instance, the application/client device may establish a session with a server, which may include a login-process, or an authentication challenge/response, etc. In any case, the client device may insert into the data traffic an indicator such as described above. Alternatively, or in addition, the generative AI system may add such an identifier to the data traffic that originated from the generative AI system.

In either case, the communication network may learn that the data traffic comprises or is related to AI/ML generative content (broadly “generative content data traffic”). In one example, the identifier may comprise one or more signaling bits in the packets of the data traffic, e.g., in a packet header field, or otherwise included in a designated location within the packet. Alternatively, or in addition, the identifier may comprise one or more signaling bits within cellular signaling messages, e.g., within 3^{rd} Generation Partnership Project (3GPP) signaling messages that indicate the presence of generative content data traffic. In one example, the identifiers may be standardized between device manufacturers and communication network operators to maintain uniformity in the use of such identifiers. In one example, a communication network may advance protocol enhancements to develop and adopt network protocols that support the identification of generative content data traffic through specific markers or headers. As noted above, the communication network may alternatively or additionally identify generative content data traffic via one or more application fingerprinting and/or data traffic fingerprinting techniques to recognize specific generative content applications based on unique network behaviors and traffic patterns. In one example, the fingerprinting techniques may comprise one or more machine learning models (MLMs), e.g., one or more classifiers trained to detect generative content data traffic and/or to identify source addresses that are associated with one or more servers of a generative AI system. In one example, the present disclosure may incorporate adaptive learning to continuously update the detection/classification algorithms/models based on new example data traffic patterns.

In one example, the present disclosure may use retrieval-augmented generation (RAG) with a LLM-based generative AI system to improve the accuracy of user commands, leading to more satisfactory outcomes. For instance, the communication network may maintain, provide, and/or make available various prompt enhancement data sets (e.g., sets of RAG content) that may be retrieved and input to a LLM or other generative models as supplemental prompt content. In one example, using the identifier(s) and knowing that a session/data stream comprises generative content data traffic, the communication network may adjust the balance between on-device processing (e.g., at the client device) and in-network processing. Similarly, the communication network may selectively route requests for generative content creation to different network-based server(s) of a generative AI system (e.g., in a public or private cloud, in an edge cloud, etc.). For instance, these decisions may be based on data traffic size, may be triggered by service or event type (e.g., real-time versus non-real time applications, gaming and entertainment versus vehicular traffic modeling/forecasting for smart city traffic management, etc.), and so forth.

In one example, the communication network and/or one or more generative AI system providers may implement caching mechanisms, e.g., at the network edge, or the like, to store frequently accessed data, thus reducing repetitive data transfers. In addition, in one example, differentiated processing/routing of requests for creation of generative content may be based on whether an endpoint/client device is relatively static (e.g., not moving or moving slowly/below a threshold speed, etc.) or is mobile/in motion. In one example, the identification of generative content data traffic may further enable a network operator to manage the substantial data volumes associated with these types of applications by providing different priorities for generative content data traffic (e.g., reduced priority for some or all types of generative content and/or generative content services). In one example, the reduced priority may be associated with a corresponding discount or service credit. However, in another example, additional charges may be authorized to permit access to a higher priority/higher class of service processing.

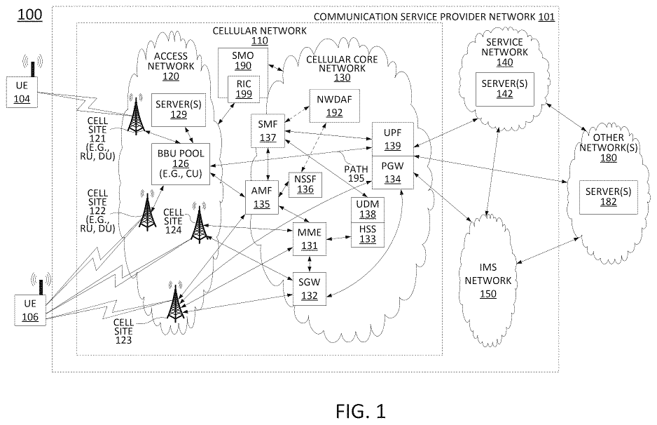

Accordingly, examples of the present disclosure effectively identify and process generative content data traffic, which can reduce network congestion. In particular, efficient network data traffic management can prevent network bottlenecks, ensuring smooth and uninterrupted service for all users. In addition, examples of the present disclosure may provide improved latency metrics (e.g., reduce latency). For instance, by prioritizing critical generative content data traffic, latency may be reduced, enhancing the user experience, especially for real-time applications. Examples of the present disclosure may also provide for more seamless interactions (e.g., a text message exchange or the like). In particular, by balancing on-device and cloud processing, faster and more responsive AI/ML-supported interactions may be provided to users. Examples of the present disclosure may also support higher accuracy of generative command creation. For instance, using retrieval-augmented generation (RAG) with a LLM-based generative AI system may improve the accuracy of user commands, leading to more satisfactory outcomes. Similarly, the present examples may provide for lower energy consumption. For instance, by optimizing for on-device processing or re-location of generative content creation (e.g., public or private cloud, edge cloud, etc.), the communication network may reduce the volume of network data traffic, leading to lower energy usage and a smaller carbon footprint. Likewise, examples of the present disclosure may benefit first responders/emergency services by enabling a network operators to provide tiered services, and to ensure that generative content data traffic for entertainment purposes does not interfere with communications that are more critical to public safety. These and other aspects of the present disclosure are discussed in greater detail below in connection with the examples of FIGS. 1-3.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include radio units (RUs)/RRHs, distributed units (DUs), and centralized units (CU) (e.g., where baseband units (BBUs) may include CUs and/or CUs in conjunction with DUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and any future generation of wireless cellular technology, e.g., 6G the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked with monitoring various network functions, network slices, and access network components. In one example, NWDAF 192 may subscribe to data analytics (e.g., performance indicators/KPIs) from a variety of NFs, may store these analytics, and may provide such analytics to other NFs that may request such data. In accordance with the present disclosure, NWDAF 192 may track various performance indicators with respect to access network 120 and/or regarding particular components thereof (such as RUs, DUs, CU, etc., e.g., cell sites 121 and 122, BBU pool 125, cell sites 123 and 124, and so forth). In one example, NWDAF 192 may also collect and store external/third-party data, such as weather data (e.g., temperature, humidity, precipitation indication, precipitation volume, etc.) that may also be used in connection with predicting/forecasting network impairment (or aspects of non-impaired network state/status) relating to access network 120 and/or portions thereof (e.g., at one or more of cell sites 121-123).

In one example, cellular network 110 may comprise a “non-stand alone” (NSA) mode architecture, where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, in another example, the present disclosure may relate to a hybrid, or integrated 4G/LTE-5G cellular core network, such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various mobile endpoint devices, e.g., user equipment (UE) 104 and 106. UE 104 and 106 may each comprise a cellular telephone, a smartphone, a tablet computing device, a laptop computer, a pair of computing glasses, a pair of wireless goggles, a wireless enabled wristwatch, a wireless transceiver for a fixed wireless broadband (FWB) deployment, or any other cellular-capable mobile telephony and computing devices (broadly, “a mobile endpoint device”). In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

As illustrated in FIG. 1, UEs 104 and 106 may register and attach to any of cell sites 121-124 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the selected cell site and establish a radio resource control (RRC) communication, transmitting a registration/attach request, performing authentication procedures, establishing a default protocol data unit (PDU) session, e.g., including bearer assignment, and so forth.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa. In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary).

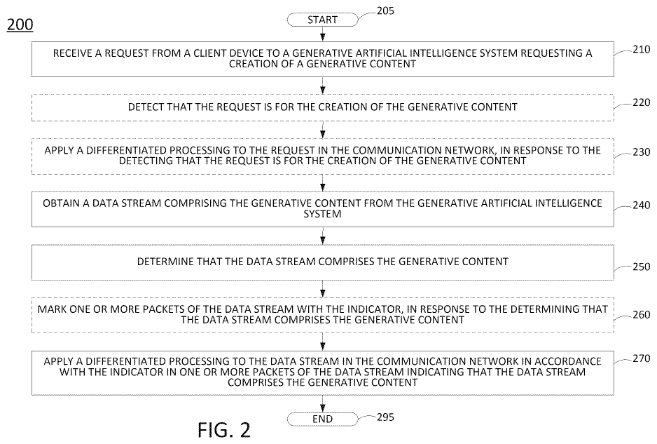

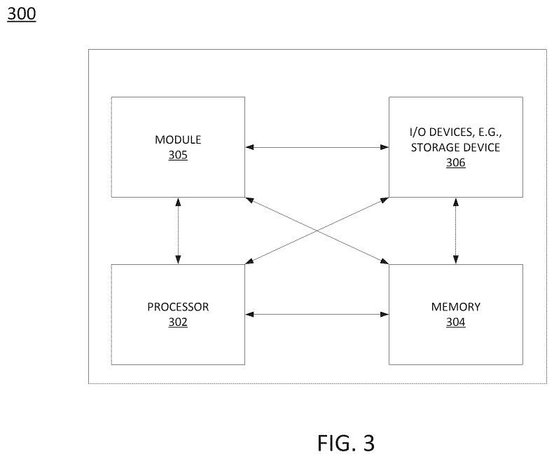

In one example, NWDAF 192 may comprise all or a portion of a computing device or system, such as computing system 300, and/or processing system 302 as described in connection with FIG. 3 below, and may be configured to perform various operations in connection with examples of the present disclosure for applying a differentiated processing to a data stream in a communication network in accordance with an indicator in one or more packets of the data stream indicating that the data stream comprises the generative content (e.g., as illustrated and described in connection with the example of FIG. 2).

In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

To further illustrate, in one example, NWDAF 192 may also train and store one or more generative content data traffic detection/classification models. For instance, the generative content data traffic detection/classification model(s) may each comprise a machine learning model. It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, NWDAF 192 may train and deploy one or more such generative content data traffic detection/classification models. For example, NWDAF 192 may train and deploy different generative content data traffic detection/classification models for detecting data traffic of different generative AI applications and/or generative AI systems, for detecting data traffic of different types of generative content (e.g., short text, long text, images, video, software programs, instructions/queries (e.g., automatically generated database queries or the like, synthetic data, system simulation modeling/forecasting, and so forth)), for detecting the foregoing with respect to different geographic regions (e.g., states, groups of states, etc.), for different tracking areas, or the like.

In accordance with the present disclosure, the generative content data traffic detection/classification models may be trained/configured to take an input vector comprising data stream source information (e.g., source IP address and/or source port of one or more packets, an identity of the client device (e.g., which may be derived from the data stream source information), or the like), data stream destination information (e.g., destination IP address and/or destination port of the one or more packets, an identity of the generative artificial intelligence system (e.g., which may be derived from the packet destination information)), packet timing information of the data stream, packet size information associated with one or more packets of the data stream, and so forth, and to generate an output comprising a classification/indicator of whether the data stream is a generative content data stream and/or whether the generative content data stream is for a particular type of generative content, is for a particular generative content application or system, or the like. Alternatively, or in addition, in one example, a generative content data traffic detection/classification model may comprise a multi-class classifier, in which case the output may be associated with a defined set/range of possible outputs/categories. For instance, the output of such a classifier may indicate which type of generative content, from among a plurality of different types of generative content, the data stream may be associated with, which generative content application/system the data traffic is associated with (from among a plurality of types of generative content applications/systems), or the like. In one example, one or more generative content data traffic detection/classification models may be trained with positive examples and negative examples of input vectors which are indicative of/associated with each category (e.g., [generative content data stream, non-generative content data stream], or [generative video, generative audio, generative text, . . . ]), and so forth. In one example, the one or more generative content data traffic detection/classification models may alternatively or additionally be trained/configured to process an input vector that may include 3GPP/cellular signaling information such as mentioned above.

In one example, NWDAF 192 may deploy the one or more generative content data traffic detection/classification models internally, e.g., processing input data/vectors and generating outputs within NWDAF 192 itself. However, in another example, the one or more trained models may be deployed to other network functions. To illustrate, a generative content data traffic detection/classification model may be deployed to AMF 135. Accordingly, AMF 135 may receive one or more packets and/or signaling messages from UE 104 via cell site 121 and BBU pool 126. The packet(s)/signaling message(s) may comprise a request for creation of generative content directed to a generative AI system associated with one or more of servers 182, for instance. In some cases, UE 104 (e.g., the application generating the request, or the like) may insert an identifier indicating that the communication(s) is/are a request for generative content and/or a request for a particular type of generative content. However, in some examples, the communication(s) may be unmarked, where AMF 135 may observe the messages/packets of the data stream, extract data relevant to the input vector for the generative content data traffic detection/classification model, and apply the input vector to the generative content data traffic detection/classification model to identify that the communication(s) is/are related to generative content.

In such case, AMF 135 may mark the packets with an identifier that indicates that one or more packets of the data stream are for generative content. Accordingly, subsequent network functions may apply a differentiated processing the data stream. For instance, path 195 may represent various routers within the cellular core network which may be configured to apply different priorities to different categories or classes of data traffic, where the indicator may signal to the routers the class/category to which the data stream belongs (e.g., a generative content data stream type/category). In one example, AMF 135 may request a slice assignment from NSSF 136, which may assign the session (e.g., data stream(s)/network data traffic thereof) to a different network slice that may be designated/reserved for generative content and/or which may be associated with a class of service to which the generative content is assigned, or the like. In one example, some or all of the foregoing described with respect to AMF 135 may alternatively or additionally be deployed in access network 120, such as a CU of BBU pool 126, for example.

Alternatively, or in addition, a generative AI system provider may grant the communication service provider network 101 permission to manage domain name and IP address assignments for the generative AI system. In addition, in one example, the generative AI system may include alternate servers that can equally perform a task of generative content creation. For instance, in the example, of FIG. 1, server(s) 129 in access network 120 (e.g., in an edge cloud), servers(s) 142 in service network 140 (e.g., in a data center/private cloud of an operator of communication service provider network 101), and server(s) 182 (e.g., in a public cloud and/or enterprise network of the generative AI system provider) may all be available and may have equal or similar capabilities in terms of processing generative content creating requests. Thus, a request from UE 104 to a generative AI system may alternatively be directed to server(s) 182, server(s) 142, and/or server(s) 129.

In one example, NWDAF 192 may include one or more additional models (e.g., AI/ML model(s) or the like) for detecting and tracking various aspects of network state, and may instruct AMF 135, UPF 139, and/or other network functions to process one or more generative content data streams differently, i.e., based on the network state. For instance, when the communication service provider network 101 and/or a relevant portion thereof is considered overloaded, there may be a preference to direct a request for creation of generative content to server(s) 182 (e.g., external to the communication service provider network 101) or to server(s) 129 (e.g., which may result in less traffic across the cellular network 110, etc., and hence a reduction in the network load). In one example, once data traffic from UE 104 is identified as being for generative content, an entire session between UE 104 and the generative AI system (i.e., bidirectional data traffic between UE 104 and server(s) 182 or the like) may be tagged with an identifier indicating that packets thereof are for generative content. For instance, differentiated handling may be applied to the packets comprising the generative content itself and/or signaling or other related messaging from the generative AI system server(s).

In this regard, in one example, NWDAF 192 may train and deploy one or more generative content data traffic processing models to generate recommendations and/or instructions for processing one or more types of generative content data traffic. For instance, a generative content data traffic processing model may comprise a machine learning model, e.g., a generative MLM that may take an input vector comprising information about a known generative content data stream and additional information about network state, and that may output a recommended handling/processing. For instance, the output may comprise a recommended network configuration or state (e.g., where changes to one or more configurable setting values for one or more network functions may cause the network to update to a desired state and which may be associated with a particular routing or other handling applied to the generative content data stream). Alternatively, or in addition, the output may comprise a set of one or more instructions that may cause one or more network functions to reconfigure to a particular state, e.g., instructions in accordance with Simple Network Management Protocol (SNMP) or the like to configure network functions, etc. To further illustrate, MLMs of the present disclosure may include an ML-based generative model, such as a language model, e.g., a “large language model” (LLM). For instance, a ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. For instance, a generative model, such as one of the foregoing, may be trained/configured to generate data stream handling decisions (and hence NF configurations) in response to a detected generative content data stream in view of various factors, such as: the type of generative content, the identity of the client device and/or the identity of the generative AI system, the network load, and so forth. In one example, the present disclosure may fine-tune a LLM to provide high-level instructions for radio access network (RAN)/cellular network-specific issues. In addition, in one example, the present disclosure may further enhance such a fine-tuned MLM to provide concrete, actionable instructions, e.g., a network slice configuration (e.g., comprising NFs, processor, memory, storage, or other resources/capabilities of such NFs etc., connections between NFs, configuration setting/parameter values, and so forth). For instance, a generative LLM of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current network and/or slice status information. In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for simple network management protocol (SNMP)-based communications or the like.

It should be noted that in some examples, it is possible that a request from UE 104 does not include an identifier indicative that the data stream is for generative content. In addition, it is further possible that the AMF 135 or other NFs fail to identify an initial request as being related to generative content. However, the same or different generative content data traffic detection/classification model(s) may be deployed in other network edge elements, such as UPF 139. Accordingly, when a session is established between UE 104 and server(s) 182, for example, packets from server(s) 182 to UE 104 may pass through UPF 139 at an ingress of communication service provider network 101. In such case, UPF 139 may similarly receive one or more packets of such a data stream, extract relevant information for an input vector, such as source IP address, source port, destination IP address, destination port, timing information, packet size information, etc. and may apply the vector to the generative content data traffic detection/classification model(s) to obtain an output indicative of whether the data stream is for generative content (and/or for a particular generative content application or system, a particular generative content type, etc.). When it is detected that the data stream is for generative content and/or of a particular type of generative content, UPF 139 may tag the one or more packets with an identifier that is indicative of a generative content data stream and/or a particular type of generative content, a particular generative AI system and/or application, etc. As such, differentiated processing via communication service provider network 101 may be implemented upon such detection.

In addition, in one example, once it is learned by UFP 139 that a session between UE 104 and server(s) 182 is for generative content, bidirectional data traffic may then be tagged with the identifier (or identifiers) indicating that the one or more packets are for a generative content data stream. For instance, UPF 139 may transmit a notification to AMF 135 and/or to a base station (e.g., a BBU in BBU pool 126) that the data traffic is for generative content. As such, the base station or AMF 135 may further cause packets from UE 104 to server(s) 182 to likewise be tagged with the same or a different indicator that indicates that the data traffic/data stream is for generative content. As such, the communication service provider network 101 may begin applying designated processing to the generative content data traffic. In one example, upon detection of a generative content data stream by UPF 139, the session may alternatively or additionally be transferred to another slice that may be designated for generative content and/or a class to which generative content (or one or more generative content types) may be assigned, and so forth.

In this regard, it should be noted that any one or more network functions or other components of cellular network 110 may comprise all or a portion of a computing device or system, such as computing system 300, and/or processing system 302 as described in connection with FIG. 3 below, and may be configured to perform various operations in connection with examples of the present disclosure for applying a differentiated processing to a data stream in a communication network in accordance with an indicator in one or more packets of the data stream indicating that the data stream comprises the generative content (e.g., as illustrated and described in connection with the example of FIG. 2). For instance, AMF 135, UPF 139, BBUs of BBU pool 125, and/or other NFs may detect generative content data traffic, may tag one or more packets of such data traffic/streams with a generative content identifier (e.g., if not already tagged by an endpoint device or generative AI system), may perform differentiated handling of such data traffic/streams (e.g., one or more packets thereof) in response to the determination that the data traffic/streams are associated with generative content, and so forth.

In one example, AMF 135, UPF 139, and/or other NFs that may be configured to detect generative content data traffic may report these detections and information about the data traffic to NWDAF 192. In one example, NWDAF 192 may maintain aggregate statistics in terms of the generative content data traffic load, such as data volume per unit time, data rates, a distribution of UEs initiating the requests, a distribution of the generative AI systems and/or servers to which the requests are directed, etc., the same or similar statistics per generative content type, and so on. In one example, NWDAF 192 may provide individual or aggregate reports to one or more other NFs, e.g., on a subscription basis and/or on-demand. For instance, SMO 190 and/or RIC 199 thereof may obtain generative content data traffic alerts, reports, or the like from NWDAF 192, and may use such information to automatically configure/reconfigure one or more aspects of cell site 121 and/or access network 120. For instance, SMO 190 and/or RIC 199 may cause traffic shaping measures to be applied to generative content data traffic, or generative content data traffic for one or more generative content categories, when the volume of generative data content exceeds a first threshold. Likewise, when the volume of generative data content exceeds a second threshold, additional measures such as rerouting of requests for generative content may be applied, e.g., directing requests to server(s) 129 instead of server(s), 142, etc. For instance, in one example, the present disclosure may implement access class blocking, selective RRC connection rejection, or the like, e.g., to rate limit traffic from a RAN to a cellular core network. Accordingly, SMO 190 and/or RIC 199 may then configure/reconfigure one or more aspects of access network 120, cellular core network 130, and/or one or more network slices deployed over the infrastructure of access network 120 and cellular core network 130. In one example, as noted above, the reconfiguring (for differentiated processing of generative content data stream(s)) may be in accordance with one or more generative models/generative MLMs. In one example, the differentiated processing may be individualized with respect to a given generative content data stream or session, or may be with respect to all generative content data streams and/or sessions traversing a portion of the network, with respect to generative content data flows of one or more particular types that are traversing a portion of the network, etc.

In one example, RIC 199 and/or SMO 190 may comprise all or a portion of a computing device or system, such as computing system 300, and/or processing system 302 as described in connection with FIG. 3 below, and may be configured to perform various operations in connection with examples of the present disclosure for applying a differentiated processing to a data stream in a communication network in accordance with an indicator in one or more packets of the data stream that the data stream comprises the generative content (e.g., as illustrated and described in connection with the example of FIG. 2). In this regard, it should also be noted that in some examples, aspects described herein with respect to NWDAF 192 may alternatively or additionally be performed by SMO 190 and/or RIC 199, and vice versa.

In one example, the communication service provider network 101 may impose incentives for voluntary reporting of generative content data streams. For instance, if UE 104 reports that messages/packets comprise a request for generative content by voluntarily including an indicator in the message(s)/packet(s) the data stream may be assigned to a higher class/higher category of service. Conversely, without voluntary reporting, the communication service provider network 101 may be left to detect the nature of the data stream on its own (e.g., via application/traffic fingerprinting using generative content data traffic detection/classification model(s)). In such case, the data traffic may be processed with reduced priority as compared to when the data traffic is voluntarily reported as being for generative content.

It should also be noted that although aspects of the present disclosure are described primarily in connection with NWDAF 192, SMO 190, and RIC 199, in other, further, and different examples, aspects of the present disclosure may alternatively or additionally be deployed in a different manner. For instance, in another example, aspects of the present disclosure for applying a differentiated processing to a data stream in a communication network in accordance with an indicator in one or more packets of the data stream indicating that the data stream comprises the generative content, e.g., as described in greater detail below in connection with the example method 200 of FIG. 2, may alternatively or additionally be deployed in one or more servers, network functions, host devices, containers, etc. that may be independent of an NWDAF, a SMO, a RIC, etc. Likewise, such a generative content detection and mitigation/handling system may be deployed in a public cloud infrastructure, on-premises, e.g., in communication service provider network 101 (e.g., in a private cloud, premises), in an edge cloud (e.g., specifically in an access network, such as access network 120), and so forth.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. In addition, although aspects of the present disclosure are described primarily in connection with a cellular network, it should be understood that other, further, and different examples may similarly apply to networks using other technologies, such as enterprise local area networks (LANs), Wi-Fi networks, fiber access networks, satellite access networks, and so forth. Thus, these and other modifications are all contemplated within the scope of the present disclosure.

FIG. 2 illustrates a flowchart of an example method 200 for applying a differentiated processing to a data stream in a communication network in accordance with an indicator in one or more packets of the data stream that the data stream comprises the generative content, in accordance with the present disclosure. In one example, steps, functions and/or operations of the method 200 may be performed by a device as illustrated in FIG. 1, e.g., a processing system comprising a cell site, a base station, a BBU, a CU, etc., an AMF, a NWDAF, a SMO and/or RIC, a UPF, or the like, or collectively via a plurality devices in FIG. 1, such as a base station, AMF, and/or UPF in conjunction with a NWDAF and/or SMO/RIC, or in other examples further in conjunction with a NSSF and/or any one or more other components in FIG. 1. In one example, the steps, functions, or operations of method 200 may be performed by a computing device or system 300, and/or a processing system 302 as described in connection with FIG. 3 below. For instance, the computing device 300 may represent at least a portion of a base station, an AMF, a UPF, a NWDAF, etc. in accordance with the present disclosure. For illustrative purposes, the method 200 is described in greater detail below in connection with an example performed by a processing system, such as processing system 302. The method 200 begins in step 205 and proceeds to step 210.

At step 210, the processing system (e.g., deployed in a communication network) receives a request from a client device directed to a generative artificial intelligence (AI) system requesting a creation of a generative content. For instance, the request may comprise one or more packets addressed to the generative AI system, which may be specified by a uniform resource locator (URL), an IP address, and IP address and port number, etc. In one example, the one or more packets may be included in and/or preceded by 3GPP signaling information. The contents of the request may include a prompt for generative content, and may specify a type of content (e.g., text, audio, image, video, computer code, computer instructions, database queries, etc.), a data size of the content, a length of the content (e.g., for text, audio, video, or the like), a resolution of the content, a target audience of the content, and so forth. In one example, the request may be conveyed over a series of messages (e.g., comprising one or more packets). In one example, the request may be in parts, some of which may be provided in response to an invitation from the generative AI system. In other words, the request may be part of the initial session establishment and signaling between the client device and the generative AI system. In one example, the request may be received at step 210 at a network edge element, such as a base station, an AMF, a provider edge (PE) router, a border element, or the like. However, in another example, the request may be received at step 210 at a different network element, such as an NWDAF, or the like. It should also be noted that in one example, the communication network may not be aware of the details of the request, or the fact that the communication(s) is/are a request. However, the processing system may still have insight into high-level information of the request, e.g., source and destination IP addresses, source and destination ports, packet size, packet timing, etc. It should also be noted that as referred to herein, a generative AI system may comprise computing resources implementing machine learning models (MLMs) that are available for generating/outputting generative content of one or more types (such as text, images, audio, video, computer programming code, computer application queries, instructions, or the like, and so forth) in response to various prompts inputs.

At optional step 220, the processing system may detect that the request is for the creation of the generative content. For example, step 220 may include detecting that one or more packets of the request include an indicator that the request is for the generative content. For instance, in one example, the indicator may be applied by the client device. In various examples, the indicator may comprise one or more signaling bits in one or more packets of the request, e.g., in a packet header field, or otherwise included in a designated location within a packet. Alternatively, or in addition, the identifier may comprise one or more signaling bits within cellular signaling messages, e.g., within 3GPP signaling messages that indicate the presence of generative content data traffic. The identifier may indicate that the packet(s)/data stream comprise or is/are associated with generative content and/or a particular type of generative content, a particular generative content provider (e.g., the generative AI system), and so forth. In one example, the detecting that the request is for the generative content may be in accordance with at least one detection model that is implemented by the processing system, such as an application fingerprinting model, e.g., a machine learning model as described above. For instance, the at least one detection model may be trained to generate a classification of the request based upon an input vector. For example, the input vector may include source information of the request, destination information of the request, an identity of the client device, an identity of the generative AI system, a type of generative content being requested, a size of the request (e.g., the request may include significant RAG content in the upload and/or could indicate in the request that the result is anticipated to be large, e.g., for a prompt such as “generate me an instructional video on how to build an airplane from scratch”), or other factors. In one example, the marking of the indicator may be applied at the network edge. For instance, the marking of the indicator may be applied by/at a PE router, a border element, a UPF, a PGW, or the like, e.g., one of the first routers within the communication network at the ingress near the client device. In one example, the edge network function/network element may comprise/may be a part of the processing system performing the method 200.

Alternatively, or in addition, the differentiated processing that is applied to the request in the communication network may include routing the request to a first generative AI server of the generative AI system, e.g., where the first generative AI server is one of a plurality of available generative AI servers of the generative AI system. For instance, servers of the plurality of generative AI servers may be deployed at a plurality of locations comprising at least two of: an edge cloud infrastructure of the communication network, a non-edge cloud infrastructure of the communication network, a public cloud infrastructure that is accessible via the communication network, an enterprise network of the generative artificial intelligence system, etc. In particular, it should be noted that in some cases, the communication network can host one or more servers on behalf of the generative AI system. In one example, optional step 220 may further include selecting the first generative AI server from among the plurality of available generative AI servers for the routing of the request. For instance, in one example, the communication network may decide the routing of the request, which can be based upon various factors such as network load in one or more portions of the network, the source and destination, the network distance, the location (e.g., there may be geographic restrictions on uploading RAG content for supplementing the prompt/input, etc.). In one example, RAG content may be cached by the communication network and may be available for users to call upon for generative content creation requests/prompts. The availability of RAG content and its location(s) may also inform the decision making entity regarding which server to send the request. In one example, the selecting may be in accordance with a machine learning model implemented by the processing system that is configured to generate a recommended selection of the generative AI server from among the plurality of available generative AI servers in response to an input vector. For instance, the input vector may comprise: source information of the request, destination information of the request, an identity of the client device, an identity of the generative AI system, a type of generative content being requested, or other factors. For instance, the request may include an identifier that is provided by the client device, which may indicate that it is a request for generative content. In one example, the identifier may further identify that the request is for a particular type of generative content. In addition, in one example, the identifier may include further information such as an urgency of the request, a willingness of the client device/client to pay for enhanced service or to receive credits, etc., a willingness to have the return of the generative content delayed and/or treated with lower priority as compared to other data traffic, and so on.

At optional step 230, the processing system may apply a differentiated processing to the request in the communication network, in response to the detecting that the request is for the creation of the generative content. For instance, in one example, the differentiated processing that is applied to the request in the communication network may include marking the request with an indicator (e.g., in response to the detecting that the request is requesting the creation of the generative content). In particular, the indicator may be to cause the differentiated processing via one or more network functions of the communication network. However, in another example, the indicator may already be present (e.g., voluntarily labeled/tagged by the client device). In one example, the differentiated processing may include selecting a routing of the request to one of several available generative AI servers. Alternatively, or in addition, the differentiated processing of the request may include making a particular slice assignment based on the indicator, applying buffering, queuing, or the like to prioritize/de-prioritize certain traffic, and so forth.

At step 240, the processing system obtains a data stream comprising the generative content from the generative artificial intelligence system. For instance, the data stream may comprise one or more packets in a data flow (e.g., sharing the same tuple of source IP address, source port, destination IP address, destination port, or the like). In one example, the obtaining may be at an edge network function/network element, such as a UPF, a PE router, a border element, etc., e.g., that is closest to the server(s) of the generative artificial intelligence system at an ingress of the communication network. However, in another example, the data stream may be received at step 240 at a different network element, such as an NWDAF, or the like.

At step 250, the processing system determines that the data stream comprises the generative content. For instance, in one example, step 250 may include determining that the one or more packets contain an indicator indicating that the data stream comprises the generative content (e.g., a same or different indicator as the indicator that may be detected in the request in some examples at optional step 220). For example, the generative AI system itself may have applied the indicator to the one or more packets. In another example, the determining that the data stream comprises the generative content may be in accordance with at least one detection model that is implemented by the processing system. For example, the at least one detection model comprises an application fingerprinting model, such as a machine learning model as described above. To further illustrate, the at least one detection model may be trained to generate a classification of the data stream based upon an input vector. As described above, the input vector may include at least one of: data stream destination information of the one or more packets (e.g., destination IP address and/or destination port, or the like), data stream source information of the one or more packet (e.g., source IP address and/or source port, or the like), packet timing information of the one or more packets, packet size information of the one or more packets, and so on. Thus, in one example, step 250 may include applying such an input vector to such a detection model (or to multiple detection models, where the input vectors for the respective detection models may be the same, or may be different (e.g., particularized to the respective models)). In one example, step 250 may be performed at a network edge, e.g., in a UPF, a border element, a provider edge router, etc. In another example, step 250 may be performed at an intermediate device in the network between the client device and the generative AI system, such as NWDAF, an application server, a SMO, etc.

At optional step 260, the processing system may mark the one or more packets of the data stream with the indicator or identifier, in response to the determining that the data stream comprises the generative content (e.g., and when the one or more packets of the data stream do not already include the indicator). As noted above, the indicator may comprise one or more signaling bits in one or more packets of the data stream/data traffic, e.g., in a packet header field, or otherwise included in a designated location within a packet. The indicator may indicate that the packet(s)/data stream comprise or is/are associated with generative content and/or a particular type of generative content, a particular generative content provider (e.g., the generative AI system), and so forth. In one example, the marking may be applied at the network edge, e.g., at a same network element/network function that may determine at step 250 that the data stream may comprise the generative content. For instance, the marking may be applied by a PE router, a border element, a UPF, a PGW, or the like, e.g., one of the first routers within the communication network at the ingress of the data stream from the generative AI system. In one example, the edge network function/network element may comprise/may be a part of the processing system performing the method 200.

At step 270, the processing system applies a differentiated processing to the data stream in the communication network in accordance with the indicator in one or more packets of the data stream indicating that the data stream comprises the generative content. For instance, the differentiated processing may include one or more of: applying a reduced priority to the data stream, reducing a throughput of the data stream, re-routing the data stream via a different network path than a network path that may be selected for one or more packets that do not include the indicator, forwarding the data stream to one or more designated network functions, reducing an allocated bandwidth of an air interface for the data stream, or the like. For instance, the reduced priority can include selective dropping of packets, where such packets may be re-sent by the generative AI system, etc. In one example, designated NFs can have buffers for low priority traffic, such as generative content or certain types/classes of generative content etc. In addition, in one example, reducing allocated bandwidth can be on fiber links (e.g., reducing a throughput) or can comprise allocating fewer carriers, physical resource block (PRBs), slots, etc. in a wireless/cellular access network portion of the communication network, or the like. In one example, the type(s) of differentiated processing may be selected in accordance with one or more generative content data traffic processing models to generate recommendations and/or instructions for processing one or more types of generative content data traffic. For instance, the processing system may generate a recommended network configuration and/or instructions for reconfiguring one or more network functions based on a detection of the generative content data stream as well as network state information, etc.

Following step 270, the method 200 proceeds to step 295 where the method 200 ends.

It should be noted that the method 200 may be expanded to include additional steps or may be modified to include additional operations with respect to the steps outlined above. For example, various steps of the method 200 may be repeated for subsequent requests for the same or different client device, for the same or different generative AI system, etc. In one example, the method 200 may be expanded to further include collecting labeled training data and training one or more MLMs implemented by the processing system. In one example, the method 200 may further include collecting network performance data as feedback for updating/retraining and/or for reinforcement learning with respect to one or more MLMs implemented for selecting differentiated processing techniques, network configuration setting values, etc. at step 270. In one example, the method 200 may further include forwarding the data stream to the client device, e.g., after other aspects of differentiated processing may be applied at step 270. In one example, the method 200 may be expanded or modified to include steps, functions, and/or operations, or other features described above in connection with the example(s) of FIG. 1 and/or FIG. 3, or as described elsewhere herein. Thus, these and other modifications are all contemplated within the scope of the present disclosure.

In addition, although not specifically specified, one or more steps, functions, or operations of the example method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for applying a differentiated processing to a data stream in a communication network in accordance with an indicator in one or more packets of the data stream indicating that the data stream comprises the generative content, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 305 for applying a differentiated processing to a data stream in a communication network in accordance with an indicator in one or more packets of the data stream that the data stream comprises the generative content (e.g., a software program comprising computer-executable instructions) can be loaded into memory 304 and executed by hardware processor element 302 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for applying a differentiated processing to a data stream in a communication network in accordance with an indicator in one or more packets of the data stream indicating that the data stream comprises the generative content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor deployed in a communication network, a request from a client device to a generative artificial intelligence system requesting a creation of a generative content;
obtaining, by the processing system, a data stream comprising the generative content from the generative artificial intelligence system;
determining, by the processing system, that the data stream comprises the generative content; and
applying, by the processing system, a differentiated processing to the data stream in the communication network in accordance with an indicator in one or more packets of the data stream indicating that the data stream comprises the generative content.

2. The method of claim 1, wherein the determining comprises determining that the one or more packets contain the indicator indicating that the data stream comprises the generative content.

3. The method of claim 2, wherein the generative artificial intelligence system has applied the indicator to the one or more packets.

4. The method of claim 1, further comprising:
marking the one or more packets of the data stream with the indicator, in response to the determining that the data stream comprises the generative content.

5. The method of claim 4, wherein the determining that the data stream comprises the generative content is in accordance with at least one detection model that is implemented by the processing system.

6. The method of claim 5, wherein the at least one detection model comprises an application fingerprinting model.

7. The method of claim 5, wherein the at least one detection model is trained to generate a classification of the data stream based upon an input vector, the input vector comprising at least one of:
data stream destination information of the one or more packets;
data stream source information of the one or more packets;
packet timing information of the one or more packets; or
packet size information of the one or more packets.

8. The method of claim 4, wherein the marking is applied at a network edge of the communication network.

9. The method of claim 4, wherein the marking is applied at an access network of the communication network.

10. The method of claim 1, wherein the differentiated processing that is applied to the data stream in the communication network comprises at least one of:
applying a reduced priority to the data stream;
reducing a throughput of the data stream;
re-routing the data stream via a different network path than a network path that is selected for one or more packets that do not include the indicator;
forwarding the data stream to one or more designated network functions; or
reducing an allocated bandwidth of an air interface for the data stream.

11. The method of claim 1, further comprising:
detecting, by the processing system, that the request is for the creation of the generative content; and
applying, by the processing system, a second differentiated processing to the request in the communication network, in response to the detecting that the request is for the creation of the generative content.

12. The method of claim 11, wherein the detecting comprises detecting that one or more packets of the request include an indicator indicating that the request is for the generative content.

13. The method of claim 12, wherein the indicator indicating that the request is for the generative content is applied by the client device.

14. The method of claim 11, wherein the second differentiated processing that is applied to the request in the communication network comprises:
marking the request with a second indicator, in response to the detecting that the request is requesting the creation of the generative content, wherein the second indicator is to cause the second differentiated processing via one or more network functions of the communication network.

15. The method of claim 11, wherein the second differentiated processing that is applied to the request in the communication network comprises:
routing the request to a first generative artificial intelligence server of the generative artificial intelligence system wherein the first generative artificial intelligence server is one of a plurality of available generative artificial intelligence servers of the generative artificial intelligence system.

16. The method of claim 15, wherein servers of the plurality of generative artificial intelligence servers are deployed at a plurality of locations comprising at least two of:
an edge cloud infrastructure of the communication network;
a non-edge cloud infrastructure of the communication network;
a public cloud infrastructure that is accessible via the communication network; or
an enterprise network of the generative artificial intelligence system.

17. The method of claim 15, wherein the second differentiated processing that is applied to the request in the communication network further comprises:
selecting the first generative artificial intelligence server from among the plurality of available generative artificial intelligence servers for the routing of the request.

18. The method of claim 17, wherein the selecting is in accordance with a machine learning model implemented by the processing system that is configured to generate a recommended selection of the generative artificial intelligence server from among the plurality of available generative artificial intelligence servers in response to an input vector.

19. A non-transitory computer-readable medium storing instructions which, when executed by a processing system including at least one processor deployed in a communication network, cause the processing system to perform operations, the operations comprising:
receiving a request from a client device to a generative artificial intelligence system requesting a creation of a generative content;
obtaining a data stream comprising the generative content from the generative artificial intelligence system;
determining that the data stream comprises the generative content; and
applying a differentiated processing to the data stream in the communication network in accordance with an indicator in one or more packets of the data stream indicating that the data stream comprises the generative content.

20. An apparatus comprising:
a processing system including at least one processor; and
a computer-readable medium storing instructions which, when executed by the processing system when deployed in a communication network, cause the processing system to perform operations, the operations comprising:
receiving a request from a client device to a generative artificial intelligence system requesting a creation of a generative content;
obtaining a data stream comprising the generative content from the generative artificial intelligence system;
determining that the data stream comprises the generative content; and
applying a differentiated processing to the data stream in the communication network in accordance with an indicator in one or more packets of the data stream indicating that the data stream comprises the generative content.
